(19) United States
(12) Patent Application Publication
(10) Pub. No.: US 2011/0226575 A1
(43) Pub. Date: Sep. 22, 2011

(54) BAG HAVING A HANDLE UNIT WITH IMPROVED PRECISION OF AN EXTENDABLE LENGTH

(75) Inventor: Hyung Joo KWON, Gwangju-si (KR)

(73) Assignee: CARIMAX CORPORATION, Gwangju-si (KR)

(21) Appl. No.: 13/048,145

(22) Filed: Mar. 15, 2011

(30) Foreign Application Priority Data
Mar. 16, 2010 (KR) 10-2010-0023255

(51) Int. Cl. A45C 13/26; F16H 1/02

(52) U.S. Cl. 190/115; 74/412 R

(57) ABSTRACT

Disclosed is a bag having a handle unit with improved precision of an extendable length. The bag includes a body and a handle unit mounted on one side of the body. The handle unit includes a housing coupled with one side of the body and having an installation space therein, a foldable section arranged in the installation space and having a configuration in which a plurality of links cross each other such that the plurality of links are extended and contracted in folded or unfolded states, a lock gear section that fixes an extendable length of the foldable section and is coupled to an upper end of the foldable section to reduce tolerance occurring when the foldable section is extended and contracted, and a lock gear adjustment section that adjusts driving of the lock gear section such that the foldable section.

### TECHNICAL FIELD

The present invention relates to a bag having a handle unit with improved precision of an extendable length. More particularly, the present invention relates to a bag having a handle unit with improved precision of an extendable length, which can maximize the convenience of a user by substantially reducing tolerance essentially occurring when a foldable section is extended and contracted.

### BACKGROUND ART

In general, bags are mainly used in order to conveniently store and carry documents, clothes, articles and the like, and have various sizes and shapes according to the use, purpose and types of articles to be stored.

Among this variety of bags, a travel bag in which many items may be stored tightly is used for the purpose of travel or overnight stays. A conventional travel bag is provided at the bottom portion thereof with a plurality of wheels and at one side thereof with a handle unit for convenient carrying. The handle unit is mounted to be inserted into or withdrawn from one side of the inside of the bag and the bag is provided therein with a support unit having a storage space into which the handle unit can be inserted. The handle unit is extendable because it has a structure in which a plurality of pipes is connected to one another and a fixed state can be maintained step by step by the support unit.

When moving the bag, a user lifts up the handle unit around the waist and carries the bag in the state where the bag is inclined from the ground by a predetermined angle.

However, since the handle unit mounted on the conventional bag occupies a large installation space because the support unit extends from the bottom portion of one side of the bag to the upper end, the space in the bag for storing items is further reduced. In addition, since the handle unit has a structure in which its length is normally adjusted in two or three steps, there is a limitation in adjusting the withdrawn length to be suitable for the height of a user.

In order to solve such problems, the present applicant filed “A handle with a foldable arm and a bag having the same (Korean patent application No. 10-2008-0090040)” on Sep. 11, 2008.

FIG. 1 is a perspective view illustrating the bag filed by the present applicant, and FIG. 2 is a schematic diagram illustrating tolerance occurring when a foldable section is extended and contracted at the time of use of the bag illustrated in FIG. 1.

Referring to FIGS. 1 and 2, the bag 1 includes a body 1a and a foldable arm 1b mounted on one side of the body 1a. The foldable arm 1b includes a foldable section 1c extended or contracted into the folded state or the unfolded state, a handle unit 1d grasped by a user, and a fixing section 1e for temporarily fixing the foldable section 1c withdrawn by a predetermined length. With such a structure, since the bag 1 can store a large number of articles due to a reduction in the installation space provided in the bag 1 as compared with the conventional structure, the performance of the product can be improved. Furthermore, since a user can freely adjust the withdrawn length of the foldable section 1c and temporarily fix the withdrawn state of the foldable section 1c regardless of positions by using the fixing section 1e, the convenience of the user is increased.

### SUMMARY OF THE INVENTION

However, as illustrated in FIGS. 1 and 2, in the bag 1, even if the foldable section 1c is withdrawn by the length desired by the user and fixed by the fixing section 1e, the foldable section 1c may be shaken up and down (hereinafter, referred to as tolerance T). That is, as the fixing section 1e is arranged separately from the foldable section 1c, the bag 1 has constant tolerance (T=T1+T2) by which the foldable section 1c may move up and down because the fixing section 1e does not accurately fix the withdrawn length of the foldable section 1c.

Since the tolerance may reduce the convenience of a user and lower the reliability of a product, the applicant of the present invention has continuously conducted various research in order to substantially reduce the tolerance, thereby filing the present patent application.

The present invention has been made to solve the above problems occurring in the prior art, and an object of the present invention is to provide a bag having a handle unit with improved precision of an extendable length, which can maximize the convenience of a user by substantially reducing tolerance essentially occurring when a foldable section is extended and contracted.

To accomplish the first object, according to the present invention, there is provided a bag having a handle unit with improved precision of an extendable length, including: a body; and a handle unit mounted on one side of the body such that a user carries the body, wherein the handle unit includes: a housing coupled with one side of the body and having an installation space therein; a foldable section arranged in the installation space and having a configuration in which a plurality of links cross each other such that the plurality of links are extended and contracted in folded or unfolded states; a lock gear section that fixes an extendable length of the foldable section and is coupled to an upper end of the foldable section to reduce tolerance occurring when the foldable section is extended and contracted; and a lock gear adjustment section that adjusts driving of the lock gear section such that the foldable section is extended and contracted according to manipulation of a user.

The lock gear section may include a first rotation gear that rotates in a clockwise direction or a counter clockwise direction when the foldable section is extended and contracted, a second rotation gear arranged adjacent to the first rotation gear and rotating in a direction opposite to a rotation direction of the first rotation gear when the foldable section is extended and contracted, and a lock gear interposed between the first rotation gear and the second rotation gear to control rotation of the first rotation gear in such a way to be engaged with or separated from the first rotation gear according to adjustment of the lock gear adjustment section.

The first rotation gear may be formed in the inner peripheral surface thereof with a plurality of lock gear grooves, and the lock gear may include a gear body, and a plurality of first teeth formed along a peripheral surface of the gear body to be engaged with the lock gear grooves.

The first rotation gear may be formed with at least one first protrusion insertion groove, and the bag may further include an adjustment member which is inserted into the first protrusion insertion groove according to the adjustment of the lock gear adjustment section to separate the first teeth from the lock gear grooves.

The second rotation gear may be formed with at least one second protrusion insertion groove, and the lock gear may further include at least one second insertion protrusion provided on one side of the gear body adjacent to the second rotation gear and having a shape corresponding to the second protrusion insertion groove.

The lock gear adjustment section may include a grasping part grasped by a user, a pair of extension parts extending from both ends of the grasping part to the adjustment member, and a pair of pressing parts provided between the extension parts and the adjustment member to press the adjustment member such that the lock gear is separated from the first rotation gear.

The adjustment member may be provided at one side thereof with a first inclination surface having a tapered shape toward an inner side from a surface thereof, and the pressing part may include a pressing protrusion having a second inclination surface corresponding to the first inclination surface.

The bag may further include a pressing plate provided adjacent to one side of the second rotation gear, and an elastic member interposed between the housing and the pressing plate to elastically press the pressing plate.

The bag may further include a centering section coupled with the first rotation gear and the second rotation gear to allow a rotational degree of the first rotation gear to coincide with a rotational degree of the second rotation gear.

The centering section may include a centering gear having a plurality of second teeth, a first rack gear provided at an upper end of the first rotation gear and having a plurality of third teeth engaged with the second teeth, and a second rack gear provided at an upper end of the second rotation gear and having a plurality of fourth teeth engaged with the second teeth.

The bag may further include a tolerance restriction section provided at a lower end of the housing and applying elastic force in a direction opposite to an extension direction of the foldable section to reduce tolerance occurring when the foldable section is extended.

The tolerance restriction section may include a guide member coupled with a link pin passing through a center portion of a pair of links arranged at the lower end of the housing among the plurality of links and moving up and down along one side of the housing, and a pair of elastic springs provided adjacent to an upper end of the guide member to apply elastic force downward when the guide member moves up.

The pair of elastic springs may be symmetrical to each other about the guide member such that one end of each elastic spring is fixed to the housing and the other end of each elastic spring is adjacent to the upper end of the guide member.

The housing may be formed at one side of the lower end thereof with a first guide slit, and the guide member may move up and down along the first guide slit.

The housing may be formed at one side of an upper end thereof with a second guide slit, and a pair of links arranged at a lower end of the housing among the plurality of links may be coupled with each other by a movable pin coupled to move up and down relative to the second guide slit such that the pair of links move up and down along the second guide slit.

The movable pin may include a first expansion part, a second expansion part spaced apart from the first expansion part by a predetermined interval, a third expansion part spaced apart from the second expansion part by a predetermined interval and protruding outward from the housing, a first small diameter part having a diameter smaller than a diameter of the first expansion part and a diameter of the second expansion part and connecting the first expansion part to the second expansion part, and a second small diameter part having a diameter smaller than a diameter of the second expansion part and a diameter of the third expansion part and connecting the second expansion part to the third expansion part.

The foldable section may include a first unit link provided at one end thereof with a coupling protrusion, a second unit link formed at one end thereof with a coupling hole into which the coupling protrusion is inserted and coupled with the first unit link.

The coupling protrusion may have a length to an extent that it protrudes through the coupling hole, and the foldable section may further include a washer coupled with one end of the coupling protrusion, a fixing pin inserted into a coupling groove formed in a center portion of the coupling protrusion and the coupling hole, and a cover member provided to cover one end of the first unit link, one end of the second unit link, and the washer.

The foldable section may include a first unit link formed at both ends thereof with a first coupling hole, a second unit link having an upper end coupled to a lower end of the first unit link and formed at both ends thereof with a second coupling hole, and a coupling pin for pivotably coupling the first unit link to the second unit link by passing through the first coupling hole and the second coupling hole.

The coupling pin may include a first protrusion protruding from one side of the first unit link, a second protrusion spaced apart from the first protrusion by a predetermined interval to be arranged at a coupling point of the first unit link and the second unit link, a third protrusion spaced apart from the second protrusion by a predetermined interval to protrude from one side of the second unit link, a first connection part having a diameter smaller than a diameter of the first protrusion and a diameter of the second protrusion and connecting the first protrusion to the second protrusion, and a second connection part having a diameter smaller than a diameter of the second protrusion and a diameter of the third protrusion and connecting the second protrusion to the third protrusion, and wherein the foldable section may include a first cover part coupled with the first connection part to cover one end of the first unit link, and a second cover part coupled with the second connection part to cover one end of the second unit link.

The first cover part may include a first rotation pin formed one side thereof with an opening and coupled with the first connection part, and a first rotation member that receives the first rotation pin therein, and the second cover part may include a second rotation pin formed one side thereof with an opening and coupled with the second connection part, and a second rotation member that receives the second rotation pin therein.

The lock gear section may include a first rotation gear rotating in a clockwise direction or a counter clockwise direction when the foldable section is extended and contracted, a second rotation gear arranged adjacent to the first rotation gear and rotating in a direction opposite to a rotation direction of the first rotation gear when the foldable section is extended and contracted, and a lock gear interposed between the first rotation gear and the second rotation gear to control rotation of the first rotation gear, wherein the lock gear adjustment section may include a push button provided adjacent to the first rotation gear to separate the lock gear from the first rotation gear according to manipulation of a user.

Each of the first rotation gear and the second rotation gear may include a rotation body, a receiving part extending from one end of the rotation body and bent, and having a gear in a longitudinal direction thereof, and a grip housing grasped by a user and formed therein with a receiving space for receiving the receiving part when the foldable section is extended and contracted.

The bag may further include a centering gear provided in the grip housing and engaged with the gear to allow a rotational degree of the first rotation gear to coincide with a rotational degree of the second rotation gear.

The bag may further include an elastic member interposed between the second rotation gear and the lock gear to elastically press the lock gear and made of an elastic material.

The bag may further include a first housing having a first end hinged to one side of the first rotation gear, and a second housing having a first end hinged to one side of the second rotation gear, wherein a second end of the first housing may be hinged to a second end of the second housing, the first end of the first housing facing the second end of the first housing, the first end of the second housing facing the second end of the second housing.

As described above, according to the present invention, it is possible to provide a bag having a handle unit with improved precision of an extendable length, capable of maximizing the convenience of a user by substantially reducing tolerance essentially occurring when a foldable section including a plurality of links crossing each other is extended and contracted by using a lock gear section coupled to the upper end of the foldable section.

### BRIEF DESCRIPTION OF THE DRAWINGS

FIG. 1 is a perspective view of “a handle with a foldable arm and a bag having the same (Korean patent application No. 10-2008-0090040)” filed by the present applicant on Sep. 11, 2008;

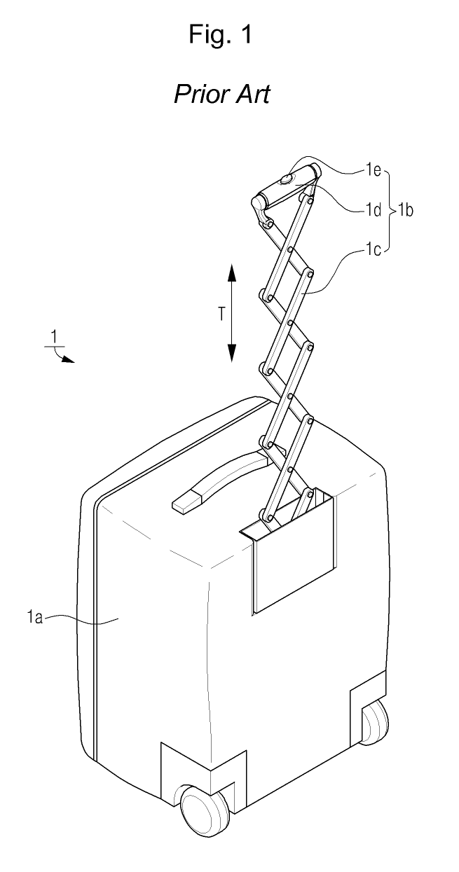

FIG. 2 is a schematic diagram illustrating tolerance occurring when a foldable section is extended and contracted at the time of use of the bag illustrated in FIG. 1;

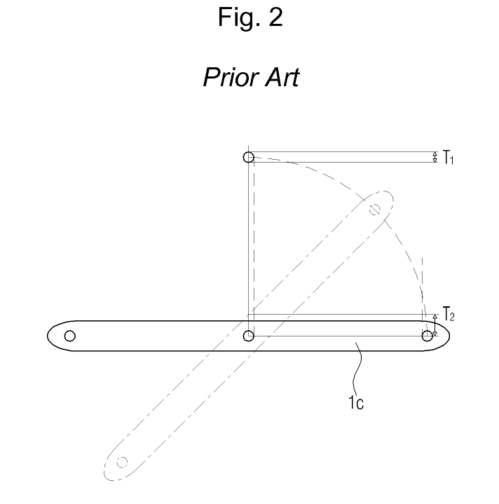

FIG. 3 is an assembled perspective view of a bag having a handle unit with improved precision of an extendable length according to a first embodiment of the present invention;

FIG. 4 is an exploded perspective view of a handle unit of the bag illustrated in FIG. 3;

FIG. 5 is a perspective view of a foldable section of the bag illustrated in FIG. 3;

FIG. 6 is an exploded perspective view of a lock gear section of the bag illustrated in FIG. 3;

FIG. 7 is an exploded perspective view of a lock gear section and a lock gear adjustment section of the bag illustrated in FIG. 3;

FIG. 8 is a schematic assembled perspective view of FIG. 7 when viewed from the side of a second rotation gear;

FIG. 9 is a schematic assembled perspective view of FIG. 6 when viewed from the side of a first rotation gear;

FIG. 10 is a perspective view of a housing and a tolerance restriction part of the bag illustrated in FIG. 3;

FIG. 11 is a schematic diagram illustrating a coupling relationship of a housing and a foldable section of the bag illustrated in FIG. 3;

FIG. 12 is a perspective view of a foldable section of a bag according to a second embodiment of the present invention;

FIG. 13 is an assembled perspective view of a lock gear section and a lock gear adjustment section of a bag according to a third embodiment of the present invention;

FIG. 14 is an exploded perspective view of a lock gear section and a lock gear adjustment section of the bag illustrated in FIG. 13;

FIG. 15 is an assembled perspective view of a lock gear section and a lock gear adjustment section of a bag according to a fourth embodiment of the present invention;

FIG. 16 is an exploded perspective view of a lock gear section and a lock gear adjustment section of the bag illustrated in FIG. 15;

### DETAILED DESCRIPTION OF THE INVENTION

Hereinafter, an exemplary embodiment of the present invention will be described with reference to the accompanying drawings. In the description of the present invention, detailed description of related well-known functions and configurations will be omitted to prevent the present invention from being ambiguous.

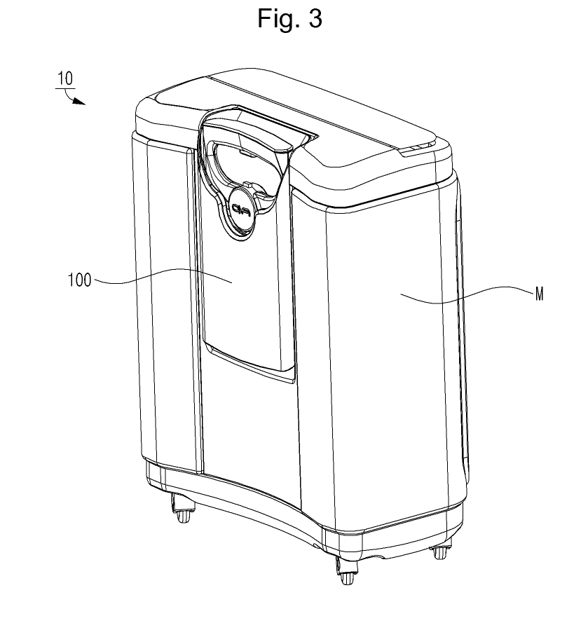

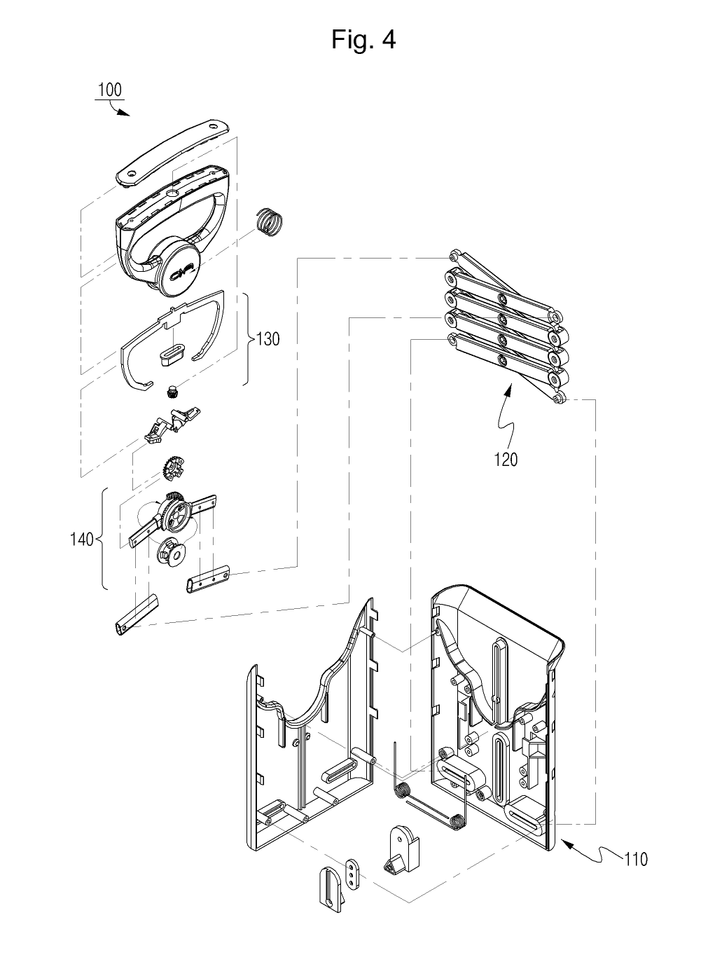

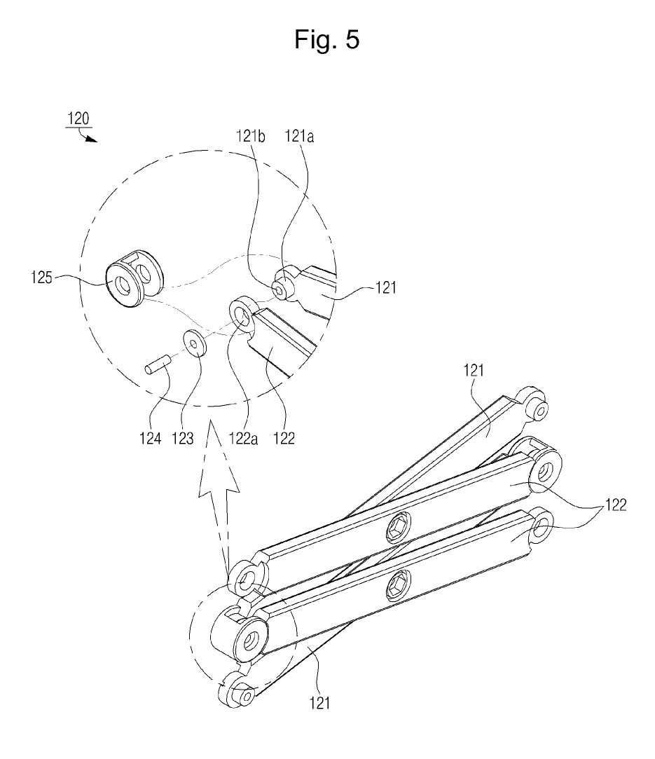

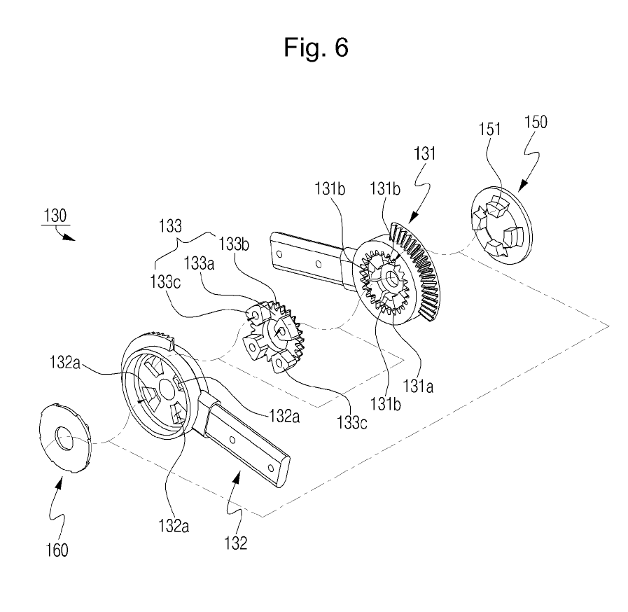

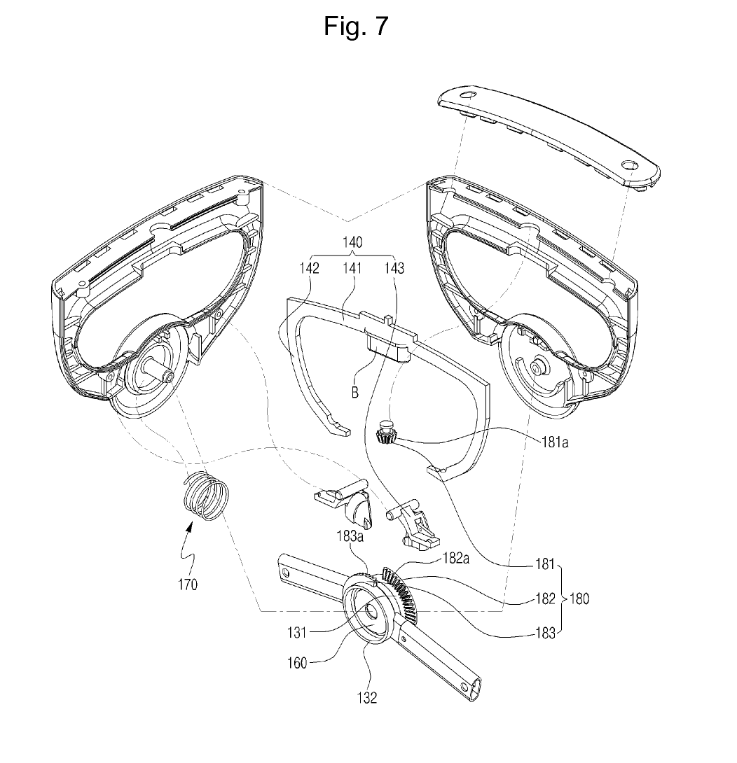

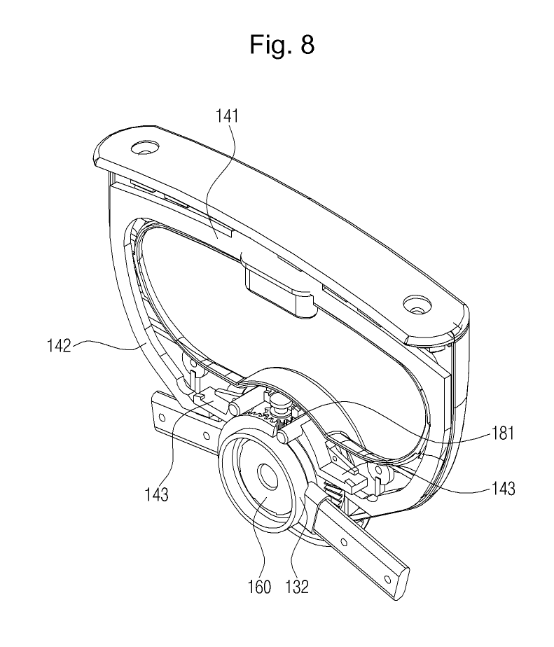

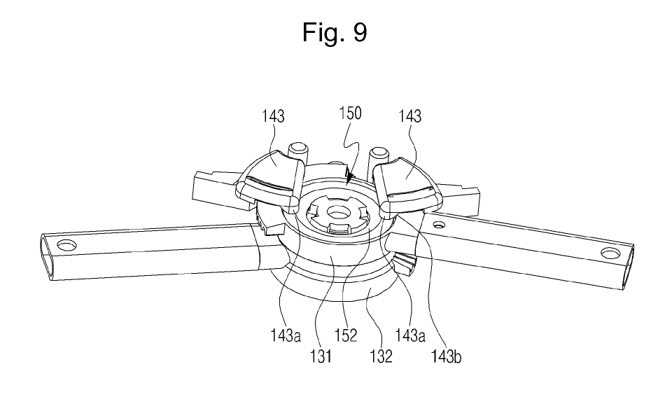

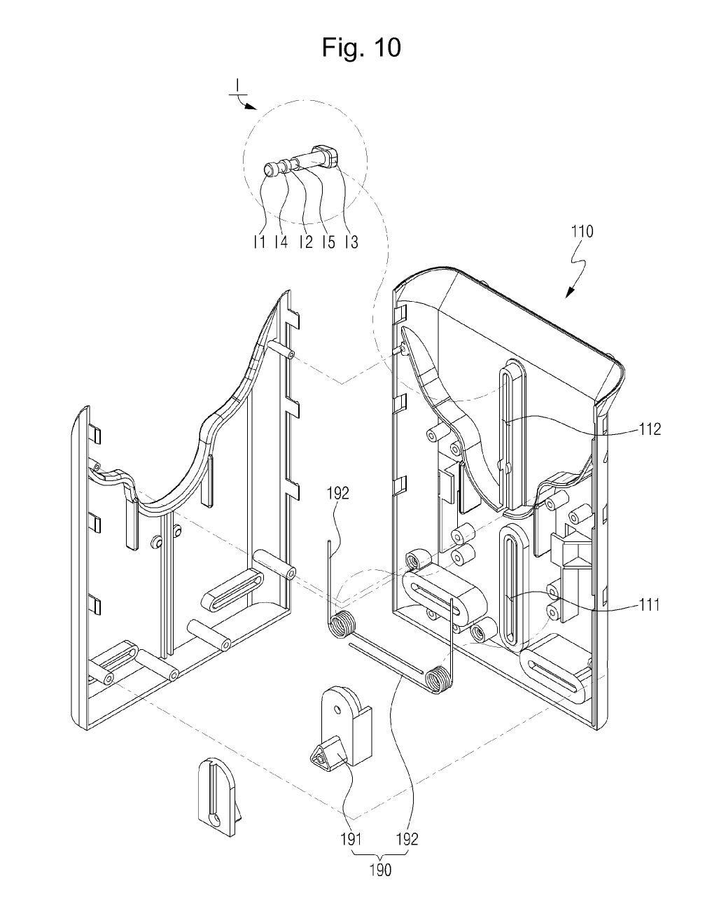

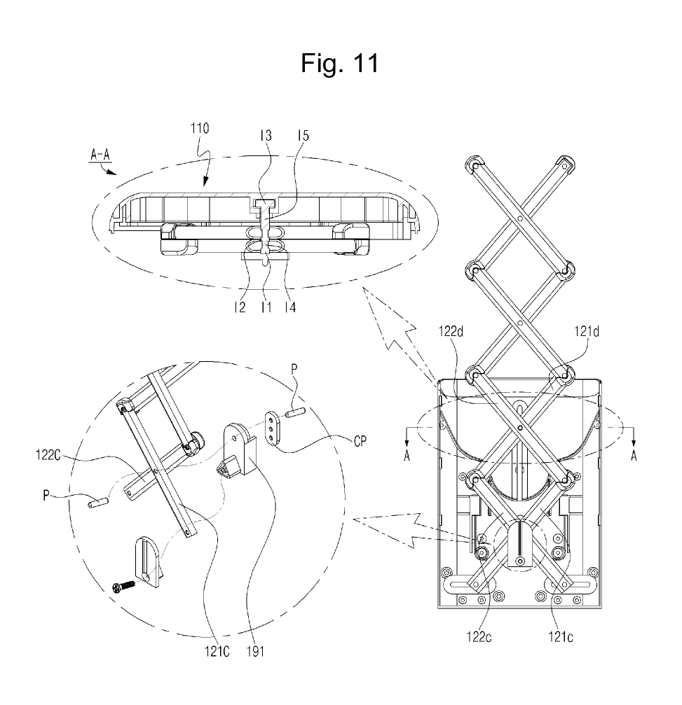

FIG. 3 is an assembled perspective view of a bag having a handle unit with improved precision of an extendable length according to a first embodiment of the present invention, FIG. 4 is an exploded perspective view of the handle unit with the improved precision of the extendable length illustrated in FIG. 3, and FIG. 5 is a perspective view of a foldable section of the bag having the handle unit with the improved precision of the extendable length illustrated in FIG. 3. FIG. 6 is an exploded perspective view of a lock gear section of the bag having the handle unit with the improved precision of the extendable length illustrated in FIG. 3, FIG. 7 is an exploded perspective view of a lock gear section and a lock gear adjustment section of the bag having the handle unit with the improved precision of the extendable length illustrated in FIG. 3, and FIG. 8 is a schematic assembled perspective view of FIG. 7 when viewed from the side of a second rotation gear. FIG. 9 is a schematic assembled perspective view of FIG. 6 when viewed from the side of a first rotation gear, FIG. 10 is a perspective view of a housing and a tolerance restriction part of the bag having the handle unit with the improved precision of the extendable length illustrated in FIG. 3, and FIG. 11 is a schematic diagram illustrating a coupling relationship of a housing and a foldable section of the bag having the handle unit with the improved precision of the extendable length illustrated in FIG. 3.

Referring to FIGS. 3 to 11, the bag (hereinafter, referred to as a bag 10) having the handle unit with the improved precision of the extendable length according to the first embodiment of the present invention includes a body M and a handle unit 100 mounted on one side of the body M.

The body M is provided at one side thereof with the handle unit 100 and has a receiving space for receiving various articles therein. Since the body M may have a configuration the same as that of a normal traveling bag, detailed description thereof will be omitted.

The handle unit 100 is detachably mounted on one side of the body M such that a user can carry the body M. The handle unit 100 includes a housing 110, a foldable section 120 arranged in an installation space provided in the housing 110, a lock gear section 130 for fixing an extendable length of the foldable section 120, and a lock gear adjustment section 140 for adjusting the driving of the lock gear section 130.

The housing 110 is detachably mounted on one side of the body

M and has an installation space therein. Detailed description thereof will be given later.

The foldable section 120 is arranged in the installation space of the housing 110 and has a configuration in which a plurality of links cross each other such that they can be extended or contracted into the folded state or the unfolded state.

As illustrated in FIG. 5, the foldable section 120 includes a first unit link 121 provided at one end thereof with a coupling protrusion 121a, a second unit link 122 formed at one end thereof with a coupling hole 122a, a washer 123 coupled with one end of the coupling protrusion 121a, a fixing pin 124 inserted into a coupling groove 121b formed in the center portion of the coupling protrusion 121a and the coupling hole 122a, and a cover member 125 provided to cover a coupling part between the first unit link 121 and the second unit link 122.

The first unit link 121 is coupled with one end of the second unit link 122 by inserting the coupling protrusion 121a into the coupling hole 122a. The coupling protrusion 121a protrudes from one end of the first unit link 121 to the extent that it protrudes passing through the coupling hole 122a of the second unit link 122, and the washer 123 is fitted around one end of the coupling protrusion 121a protruding from the coupling hole 122a. Furthermore, the fixing pin 124 is inserted into the coupling groove 121b formed in the center portion of the coupling protrusion 121a and the coupling hole 122a, so that the first unit link 121 and the second unit link 122 are pivotably coupled with each other. Since the fixing pin 124 is press-fitted into the coupling groove 121b, durability can be ensured even if the first unit link 121 and the second unit link 122, which are pivotably moved relative to each other, are repeatedly used.

The cover member 125 covers and fastens one end of the first unit link 121 and one end of the second unit link 122 to prevent the first unit link 121 and the second unit link 122 from being separated from each other when the first unit link 121 and the second unit link 122 are pivotably moved relative to each other.

The foldable section 120 is extended and contracted according to the manipulation of a user and the first unit link 121 and the second unit link 122 are repeatedly linked with each other such that the foldable section 120 can be withdrawn by a length as required by the user.

Meanwhile, the lock gear section 130 fixes the extendable length of the foldable section 120 and is coupled to the upper end of the foldable section 120 to reduce tolerance occurring when the foldable section 120 is extended and contracted.

The lock gear section 130 includes a first rotation gear 131 rotating in the clockwise direction or counter clockwise direction when the foldable section 120 is extended and contracted, a second rotation gear 132 rotating in the direction opposite to the rotation direction of the first rotation gear 131 when the foldable section 120 is extended and contracted, and a lock gear 133 interposed between the first rotation gear 131 and the second rotation gear 132.

The first rotation gear 131 is connected to one end of the foldable section 120 and rotates in the clockwise direction or counter clockwise direction when the foldable section 120 is extended and contracted. The first rotation gear 131 includes a plurality of lock gear grooves 131a formed in the inner peripheral surface thereof, and four first protrusion insertion grooves 131b formed by passing through areas where the lock gear grooves 131a are formed.

The lock gear grooves 131a are formed along the inner peripheral surface of the first rotation gear 131 to be engaged with a plurality of first teeth 133b provided along one side of a gear body 133a of the lock gear 133 which will be described later, and the first protrusion insertion grooves 131b are formed by passing through the areas where the lock gear grooves 131a are formed such that first insertion protrusions 151 of an adjustment member 150, which will be described later, can be inserted into or separated from the first protrusion insertion grooves 131b. In the present embodiment, the number of the first protrusion insertion grooves 131b is four. However, the number of the first protrusion insertion grooves 131b may be four or more or less according to the number of the first insertion protrusions 151.

The second rotation gear 132 is connected to one end of the foldable section 120 and rotates in the direction opposite to the rotation direction of the first rotation gear 131 when the foldable section 120 is extended and contracted. The second rotation gear 132 is formed with four second protrusion insertion grooves 132a into which second insertion protrusions 133c of the lock gear 133, which will be described later, can be inserted. Similarly to the first protrusion insertion grooves 131b as described above, the number of the second protrusion insertion grooves 132a may be four or more or less according to the number of the second insertion protrusions 133c.

The lock gear 133 is interposed between the first rotation gear 131 and the second rotation gear 132 and engaged with or separated from the first rotation gear 131 according to the adjustment of the lock gear adjustment section 140 to control the rotation of the first rotation gear 131. The lock gear 133 includes the gear body 133a forming a frame, the first teeth 133b formed along the peripheral surface of the gear body 133a, and the four second insertion protrusions 133c protruding from the surface of the lock gear 133 adjacent to the second rotation gear 132.

The gear body 133a forms the frame of the lock gear 133 and is a metallic member having a circular sectional shape as illustrated in FIG. 6.

The first teeth 133b are formed along the peripheral surface of the gear body 133a and inserted into the lock gear grooves 131a of the first rotation gear 131, and the four second insertion protrusions 133c protrude from one side of the lock gear 133 which is adjacent to the second rotation gear 132.

The lock gear 133 is engaged with or separated from the first rotation gear 131 according to the driving of the lock gear adjustment section 140 pressing the adjustment member 150, thereby adjusting the extendable length of the foldable section 120. That is, if the lock gear adjustment section 140 is driven according to the manipulation of a user, the first insertion protrusions 151 of the adjustment member 150 connected to the lock gear adjustment section 140 are inserted into the first protrusion insertion grooves 131b of the first rotation gear 131, and thus the lock gear 133 is separated from the first rotation gear 131, so that the first unit link 121 and the second unit link 122 are pivotably moved relative to each other, resulting in the extension of the foldable section 120. Detailed description thereof will be given later.

The lock gear adjustment section 140 adjusts the driving of the lock gear section 130 such that the foldable section 120 can be extended and contracted or fixed according to the manipulation of a user. As illustrated in FIG. 7, the lock gear adjustment section 140 includes a grasping part 141, a pair of extension parts 142 extending from both ends of the grasping part 141 to the adjustment member 150, and a pair of pressing parts 143 provided between the extension parts 142 and the adjustment member 150 to press the adjustment member 150.

The grasping part 141 is grasped by a user and includes a fixed button B protruding from the lower surface of the lock gear adjustment section 140, and the extension parts 142 extend from both ends of the grasping part 141 to the adjustment member 150 while being integrally formed with the grasping part 141.

The pressing parts 143 are provided between the extension parts 142 and the adjustment member 150 to press the adjustment member 150 such that the lock gear 133 can be separated from the first rotation gear 131. As illustrated in FIG. 9, each pressing part 143 includes a pressing protrusion 143a having a second inclination surface 143b corresponding to a first inclination surface 152 formed at one side of the adjustment member 150.

If a user lifts up the grasping part 141 with one hand, the extension parts 142 integrally formed with the grasping part 141 move upward, and thus the pressing protrusions 143a provided at the pressing parts 143 press the adjustment member 150 toward the first rotation gear 131 while moving outward along the first inclination surface 152 of the adjustment member 150. Therefore, the first insertion protrusions 151 provided at the adjustment member 150 are inserted into the first protrusion insertion grooves 131b of the first rotation gear 131, and thus the lock gear 133 is separated from the first rotation gear 131, so that the first unit link 121 and the second unit link 122 can pivot relative to each other. In such a state, if the user continuously lifts up the grasping part 141, the first unit link 121 and the second unit link 122 pivot relative to each other, so that the foldable section 120 can be extended.

Meanwhile, the adjustment member 150 separates the lock gear 133 from the first rotation gear 131 according to the adjustment of the lock gear adjustment section 140. The adjustment member 150 includes the four first insertion protrusions 151 protruding from the surface of one side thereof, and the first inclination surface 152 having a tapered shape toward the inner side from the surface of an opposite side thereof.

The first insertion protrusions 151 are inserted into the first protrusion insertion grooves 131b of the first rotation gear 131 by the pressing of the lock gear adjustment section 140, more exactly, the pressing protrusions 143a, thereby separating the lock gear 133 from the first rotation gear 131. The first inclination surface 152 is tapered from the surface to the inner side thereof such that the pressing protrusion 143a can easily move outward.

Meanwhile, the bag 10 according to the present embodiment further includes a pressing plate 160 provided adjacent to one side of the second rotation gear 132, an elastic member 170 interposed between the housing 110 and the pressing plate 160, a centering section 180 for allowing the rotational degree of the first rotation gear 131 to coincide with the rotational degree of the second rotation gear 132, and a tolerance restriction section 190 provided at the lower end of the housing 110 to reduce tolerance occurring when the foldable section 120 is extended.

The pressing plate 160 is provided adjacent to one side of the second rotation gear 132 to allow the lock gear 133 to be normally engaged with the first rotation gear 131 by the pressing of the elastic member 170, and the elastic member 170 elastically presses the pressing plate 160. In the present embodiment, the elastic member 170 is prepared in the form of a general coil spring. However, the scope of the present invention is not limited thereto. The pressing plate 160 is provided at one side thereof with four protrusions (not shown), which faces the second rotation gear 132, and the protrusions are normally inserted into the second protrusion insertion grooves 132a of the second rotation gear 132 by the pressing of the elastic member 170, so that the lock gear 133 can be engaged with the first rotation gear 131.

The centering section 180 is provided at the upper ends of the first rotation gear 131 and the second rotation gear 132 to allow the rotational degree of the first rotation gear 131 to coincide with the rotational degree of the second rotation gear 132.

The centering section 180 includes a centering gear 181, a first rack gear 182 provided at the upper end of the first rotation gear 131, and a second rack gear 183 provided at the upper end of the second rotation gear 132.

The first rack gear 182 has a plurality of third teeth 182a formed at a predetermined area of an upper end of the first rotation gear 131, the second rack gear 183 has a plurality of fourth teeth 183a formed at a predetermined area of an upper end of the second rotation gear 132, and the centering gear 181 has a plurality of second teeth 181a engaged with the third teeth 182a and the fourth teeth 183a.

As illustrated in FIG. 8, as the centering gear 181 rotates, the first rack gear 182 and the second rack gear 183 rotate opposite to each other with the same rotational degree, so that the first unit link 121 and the second unit link 122 constituting the foldable section 120 are extended and contracted by the same degree, resulting in the stable extension and contraction of the foldable section 120.

Meanwhile, the tolerance restriction section 190 applies elastic force in a direction opposite to the extension direction of the foldable section 120, thereby reducing tolerance occurring when the foldable section 120 is extended.

The tolerance restriction section 190 includes a guide member 191 provided at the lower end of the housing 110 and a pair of elastic springs 192 provided adjacent to the upper end of the guide member 191.

The guide member 191 is coupled with a link pin P and moves up and down along one side of the housing 110. The link pin P passes through the center portion of a pair of links 121c and 122c arranged at the lower end of the housing 110 from among links 121 and 122 constituting the foldable section 120. As illustrated in FIG. 10, a first guide slit 111 is formed by passing through the lower end of the housing 110, and the link pin P passes through the first guide slit 111 along the pair of links 121c and 122c arranged at the lower end of the housing 110 and the guide member 191 and then is fixed by a blocking member CP outside the housing 110. Thus, the guide member 191 moves up and down along the first guide slit 111 when the foldable section 120 is extended and contracted.

The pair of elastic springs 192 are provided adjacent to the upper end of the guide member 191 to apply elastic force downward when the guide member 191 moves up. The pair of elastic springs 192 are symmetrical to each other about the guide member 191 such that one end of each elastic spring 192 is fixed to the housing 110 and the other end of each elastic spring 192 is adjacent to the upper end of the guide member 191. If the guide member 191 moves up, the pair of elastic springs 192 provided adjacent to the upper end of the guide member 191 apply elastic force to the guide member 191 in the downward direction, so that the tolerance occurring when the foldable section 120 is extended can be substantially reduced.

Referring to FIG. 10, a second guide slit 112 is formed by passing through the upper end of the housing 110 which is adjacent to the first guide slit 111. Furthermore, a pair of links 121d and 122d arranged adjacent to the pair of links 121c and 122c arranged at the lower end of the housing 110 are coupled with each other by a movable pin I moved up and down relative to the second guide slit 112, so that the links 121d and 122d move up and down.

As illustrated in FIG. 10, the movable pin I includes a first expansion part I1, a second expansion part I2 spaced apart from the first expansion part I1 by a predetermined interval, a third expansion part I3 spaced apart from the second expansion part I2 by a predetermined interval, a first small diameter part I4 connecting the first expansion part I1 to the second expansion part I2, and a second small diameter part I5 connecting the second expansion part I2 to the third expansion part I3.

The first expansion part I1 protrudes outward from the pair of links 121d and 122d, the second expansion part I2 is coupled with the pair of links 121d and 122d over the coupling part, and the third expansion part I3 protrudes outward from the housing 110 to move along the second guide slit 112. The first small diameter part I4 has a diameter smaller than those of the first expansion part I1 and the second expansion part I2 and connects the first expansion part I1 to the second expansion part I2. The second small diameter part I5 has a diameter smaller than those of the second expansion part I2 and the third expansion part I3 and connects the second expansion part I2 to the third expansion part I3. Due to the movable pin I having the above shape, the foldable section 120 can stably move up and down relative to the housing 110 along the second guide slit 112 without being shaken in the front and rear direction of the housing 110.

Hereinafter, a method for using the bag 10 according to the present embodiment will be briefly described.

First, in order to carry the bag 10 in the state where the handle unit 100 is mounted on the body M, a user grasps the grasping part 141 of the lock gear adjustment section 140 and lifts up the grasping part 141. If the user lifts up the grasping part 141, the extension parts 142 integrally formed with the grasping part 141 slightly move up, so that the pressing protrusion 143a with the second inclination surface 143b of the pressing part 143 moves outward along the first inclination surface 152 of the adjustment member 150.

As the pressing protrusion 143a moves, the first insertion protrusions 151 of the adjustment member 150 are inserted into the first protrusion insertion grooves 131b of the first rotation gear 131 to push the lock gear 133 engaged with the first rotation gear 131 toward the second rotation gear 132, and the second insertion protrusions 133c provided at the lock gear 133 are inserted into the second protrusion insertion grooves 132a of the second rotation gear 132, so that the lock gear 133 is separated from the first rotation gear 131.

As the lock gear 133 is separated from the first rotation gear 131, the first rotation gear 131 and the second rotation gear 132 can pivot relative to each other. If the user continuously lifts up the grasping part 141, the first rotation gear 131 and the second rotation gear 132 pivot relative to each other, so that the foldable section 120 is extended. When the foldable section 120 is extended, since the rotational degree of the first rotation gear 131 is allowed to coincide with the rotational degree of the second rotation gear 132 by the centering section 180, the plurality of links of the foldable section 120 are extended by the same degree. Furthermore, the pair of links 121d and 122d arranged at the lower end of the housing 110 among the plurality of links constituting the foldable section 120 are coupled to move up and down relative to the housing 110 by the movable pin I, thereby preventing the foldable section 120 from being shaken in the front and rear direction.

If the user unfolds the foldable section 120 by the length corresponding to the height of the user, since the user releases the grasping part 141, the extension parts 142 slightly move down. In such a case, the protrusions provided at the pressing plate 160 are inserted into the second protrusion insertion grooves 132a of the second rotation gear 132 by the elastic force of the elastic member 170 to push the second insertion protrusions 133c of the lock gear 133, so that the first teeth 133b of the lock gear 133 are engaged with the lock gear grooves 131a of the first rotation gear 131 to push the adjustment member 150. Thus, since the first rotation gear 131 and the second rotation gear 132 cannot pivot relative to each other, the foldable section 120 is prevented from being extended.

Furthermore, since the tolerance restriction section 190 continuously supplies constant elastic force in the downward direction in the state where the foldable section 120 is extended, the tolerance of the foldable section 120 can be reduced.

The bag 10 according to the present embodiment has an advantage that it is possible to reduce about 60% or more of the tolerance occurring in “a handle with an foldable arm and a bag having the same (Korean patent application No. 10-2008-0090040)” which was filed on Sep. 11, 2008 by present applicant by using the lock gear section 130 coupled with the upper end of the foldable section 120. That is, in the bag previously filed by present applicant, due to the characteristics of the fixing section provided separately from the foldable section, when the foldable section is extended and contracted, constant tolerance essentially occurs. However, in the bag 10 according to the present embodiment, the lock gear section 130 for adjusting the extendable length of the foldable section 120 is coupled with the upper end of the foldable section 120, thereby preventing tolerance very efficiently. Furthermore, in the bag 10 according to the present embodiment, the tolerance restriction section 190 applying elastic force in a direction opposite to the extension direction of the foldable section 120 is additionally provided, thereby reducing tolerance of 30% or more as compared with the bag previously filed by present applicant.

In conclusion, the bag 10 according to the present embodiment has excellent effects in that it is possible to reduce tolerance of 90% or more by using the foldable section 120 provided at the upper end of the foldable section 120 and the tolerance restriction section 190 provided at the lower end of the housing 110, as compared with the bag previously filed by present applicant, thereby maximizing the convenience of a user.

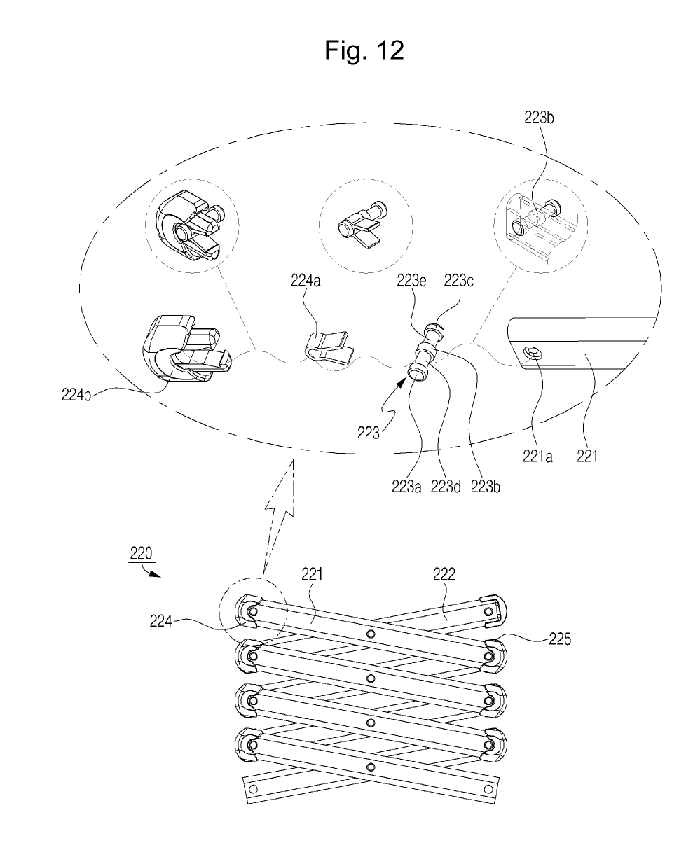

FIG. 12 is a perspective view of a foldable section of a bag according to a second embodiment of the present invention.

Referring to FIG. 12, the bag according to the second embodiment of the present invention includes a body and a handle unit mounted on one side of the body. The handle unit includes a housing (not shown), a foldable section 220 arranged in an installation space in the housing (not shown), a lock gear section (not shown) for fixing an extendable length of the foldable section 220, and a lock gear adjustment section (not shown) for adjusting the driving of the lock gear section (not shown).

Since the body, the housing, the lock gear section, and the lock gear adjustment section are substantially identical to the body M, the housing 110, the lock gear section 130, and the lock gear adjustment section 140 according to the first embodiment, detailed description thereof will be omitted in order to avoid redundancy.

The foldable section 220 is arranged in the installation space of the housing and has a configuration in which a plurality of links cross each other such that they can be extended and contracted in folded or unfolded states.

As illustrated in FIG. 12, the foldable section 220 includes a first unit link 221 formed at both ends thereof with a first coupling hole 221a, a second unit link 222 formed at both ends thereof with a second coupling hole (not shown), a coupling pin 223 for coupling the first unit link 221 to the second unit link 222, a first cover part 224 for covering one end of the first unit link 221, and a second cover part 225 for covering one end of the second unit link 222.

The first unit link 221 and the second unit link 222 are coupled to each other by the coupling pin 223, which is inserted into the first coupling hole 221a and the second coupling hole formed at both ends thereof, thereby pivoting relative to each other.

As illustrated in FIG. 12, the coupling pin 223 includes a first protrusion 223a, a second protrusion 223b spaced apart from the first protrusion 223a by a predetermined interval, a third protrusion 223c spaced apart from the second protrusion 223b by a predetermined interval, a first connection part 223d for connecting the first protrusion 223a to the second protrusion 223b, and a second connection part 223e for connecting the second protrusion 223b to the third protrusion 223c.

The first protrusion 223a protrudes from one side of the first unit link 221, the second protrusion 223b is arranged at a coupling point between the first unit link 221 and the second unit link 222, and the third protrusion 223c protrudes from one side of the second unit link 222. The first connection part 223d has a diameter smaller than those of the first protrusion 223a and the second protrusion 223b and connects the first protrusion 223a to the second protrusion 223b. The second connection part 223e has a diameter smaller than those of the second protrusion 223b and the third protrusion 223c and connects the second protrusion 223b to the third protrusion 223c.

The first cover part 224 is coupled with the first connection part 223d to cover one end of the first unit link 221, and includes a first rotation pin 224a and a first rotation member 224b for receiving the first rotation pin 224a.

The first rotation pin 224a is formed at one side thereof with an insertion space into which the first connection part 223d is inserted, and the first rotation member 224b receives the first rotation pin 224a therein. Furthermore, a second rotation pin 225a is formed at one side thereof with an insertion space into which the second connection part 223e is inserted, and a second rotation member 225b receives the second rotation pin 225a therein.

The first unit link 221 is coupled with the second unit link 222 by the coupling pin 223 provided with the second protrusion 223b at the coupling point thereof, the first connection part 223d of the coupling pin 223 is inserted into the first rotation member 224b while being received in the first rotation pin 224a, and the second connection part 223e of the coupling pin 223 is inserted into the second rotation member 225b while being received in the second rotation pin 225a.

With such a configuration, the first unit link 221 and the second unit link 222 can pivot relative to each other while being firmly coupled with each other, and durability can be constantly ensured even when the foldable section 220 according to the present embodiment is repeatedly used.

Meanwhile, according to other embodiments of the present invention, the first rotation pin 224a may be integrally formed with the first rotation member 224b while being coupled with the first rotation member 224b, and similarly to this, the second rotation pin 225a may be integrally formed with the second rotation member 225b while being coupled with the second rotation member 225b. Furthermore, the first rotation pin 224a, the first rotation member 224b, the second rotation pin 225a, and the second rotation member 225b may have various shapes as the occasion demands, and the scope of the present invention is not limited to the previous embodiments.

The foldable section 220 is extended and contracted according to the manipulation of a user and the first unit link 221 and the second unit link 222 are repeatedly connected to each other such that the foldable section 220 can be withdrawn by a length desired by the user.

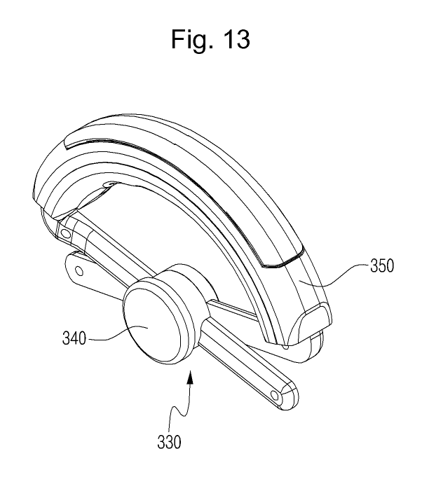

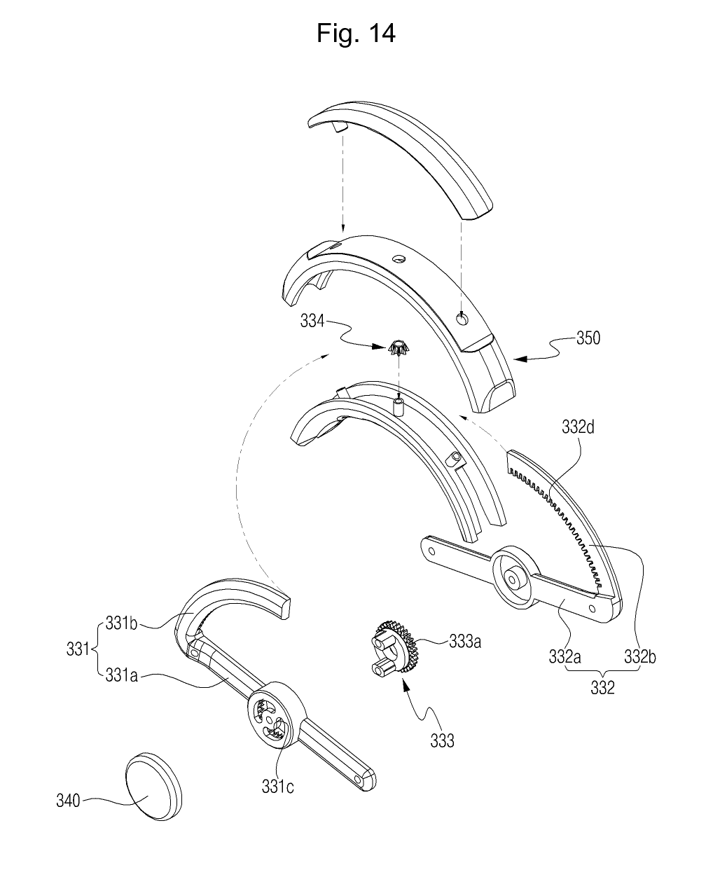

FIG. 13 is an assembled perspective view of a lock gear section and a lock gear adjustment section of a bag according to a third embodiment of the present invention, and FIG. 14 is an exploded perspective view of the lock gear section and the lock gear adjustment section of the bag illustrated in FIG. 13.

Referring to FIGS. 13 and 14, the bag according to the third embodiment of the present invention includes a body and a handle unit mounted on one side of the body. The handle unit includes a housing (not shown), a foldable section (not shown) arranged in an installation space in the housing (not shown), a lock gear section 330 for fixing an extendable length of the foldable section (not shown), a lock gear adjustment section 340 for adjusting the driving of the lock gear section 330, and a grip housing 350 grasped by a user.

Since the body, the housing, and the foldable section are substantially identical to the body M, the housing 110, and the foldable section 120 according to the first embodiment, detailed description thereof will be omitted in order to avoid redundancy.

The lock gear section 330 includes a first rotation gear 331 rotating in the clockwise direction or counter clockwise direction when the foldable section is extended and contracted, a second rotation gear 332 rotating in the direction opposite to the rotation direction of the first rotation gear 331 when the foldable section is extended and contracted, and a lock gear 333 interposed between the first rotation gear 331 and the second rotation gear 332.

The first rotation gear 331 includes a rotation body 331a and a receiving part 331b extending from one end of the rotation body 331a while being bent, and the second rotation gear 332 includes a rotation body 332a and a receiving part 332b extending from one end of the rotation body 332a and bent.

The rotation body 331a of the first rotation gear 331 forms a frame of the first rotation gear 331 and is formed at the inner peripheral surface of the center area thereof with a plurality of teeth 331c which can be engaged with a plurality of teeth 333a formed along the peripheral surface of the lock gear 333.

The receiving part 331b extends from one end of the rotation body 331a and is bent, and is received in the grip housing 350. A gear (not shown) to be engaged with a centering gear 334, which will be described later, is provided in the longitudinal direction of the receiving part 331b.

Since the rotation body 332a and the receiving part 332b of the second rotation gear 332 are substantially identical to the rotation body 331a and the receiving part 331b of the first rotation gear 331, detailed description thereof will be omitted in order to avoid redundancy. Reference numeral 332d illustrated in FIG. 14 indicates a gear formed at the receiving part 332b of the second rotation gear 332.

As illustrated in FIGS. 13 and 14, the lock gear adjustment section 340 is prepared in the form of a push button coupled with one side of the first rotation gear 331, and the grip housing 350 is formed therein with a receiving space capable of receiving the receiving part 331b of the first rotation gear 331 and the receiving part 332b of the second rotation gear 332.

A method for using the bag according to the present embodiment will be briefly described below.

First, if a user presses the lock gear adjustment section 340 prepared in the form of the push button in order to use the bag, a protrusion (not shown) formed at the inner side of the lock gear adjustment section 340 pushes protrusions 333b formed at the lock gear 333. Thus, the lock gear 333 is separated from the first rotation gear 331, so that the first rotation gear 331 and the second rotation gear 332 can rotate.

Then, if the user lifts up the grip housing 350, the first rotation gear 331 and the second rotation gear 332 start to rotate and the foldable section is extended. In such a case, the receiving part 331b of the first rotation gear 331 and the receiving part 332b of the second rotation gear 332 are gradually received in the grip housing 350. Furthermore, as the centering gear 334 is adjusted, unit links constituting the foldable section are extended by the same degree.

If the user extends the foldable section to correspond to his/her height, since the user releases the lock gear adjustment section 340, an elastic member (not shown) provided between the lock gear 333 and the second rotation gear 332 pushes the lock gear 333 toward the first rotation gear 331 to allow the lock gear 333 be engaged with the first rotation gear 331, so that the foldable section is not extended.

According to the bag of the present embodiment, the convenience of a user can be improved because the first rotation gear 331 and the second rotation gear 332 including the receiving part 331b and the receiving part 332b, which are receiving in the grip housing 350, may follow the movement direction of the foldable section.

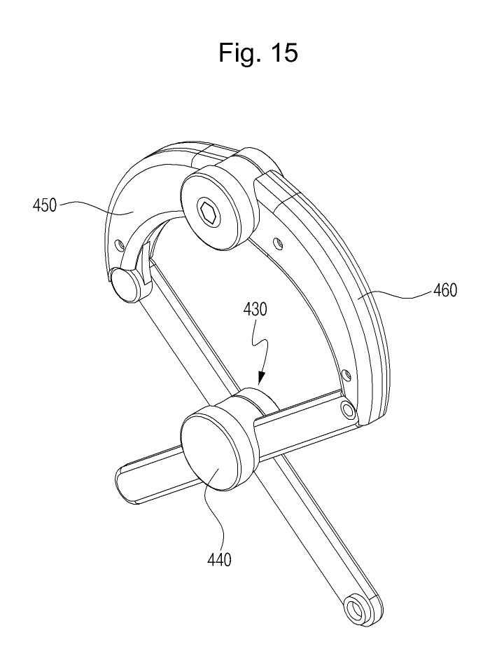

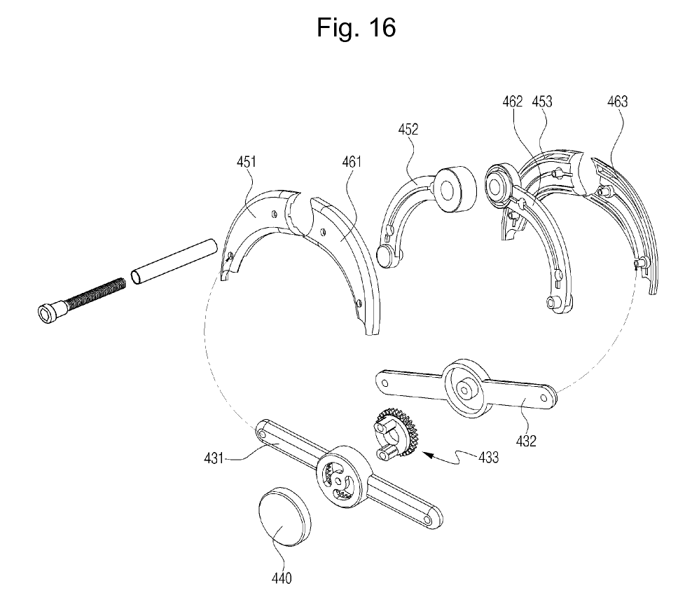

FIG. 15 is an assembled perspective view of a lock gear section and a lock gear adjustment section of a bag according to a fourth embodiment of the present invention, and FIG. 16 is an exploded perspective view of the lock gear section and the lock gear adjustment section of the bag illustrated in FIG. 15.

Referring to FIGS. 15 and 16, the bag according to the fourth embodiment of the present invention includes a body and a handle unit mounted on one side of the body. The handle unit includes a housing (not shown), a foldable section (not shown) arranged in an installation space in the housing (not shown), a lock gear section 430 for fixing an extendable length of the foldable section (not shown), a lock gear adjustment section 440 for adjusting the driving of the lock gear section 430, a first housing 450 grasped by a user, and a second housing 460.

Since the body, the housing, and the foldable section are substantially identical to the body M, the housing 110, and the foldable section 120 according to the first embodiment, detailed description thereof will be omitted in order to avoid redundancy. Furthermore, since a first rotation gear 431 and a second rotation gear 432 constituting the lock gear section 430 are substantially identical to the first rotation gear 331 not having the receiving part 331b and the second rotation gear 332 not having the receiving part 332b, detailed description thereof will be omitted in order to avoid redundancy.

The first housing 450 is divided into three members 451 to 453 coupled with each other, so that one end of the first housing 450 is hinged to one side of the first rotation gear 431, and the second housing 460 is divided into three members 461 to 463 and one end of the second housing 460 after the three members 461 to 463 are coupled to one another is hinged to one side of the second rotation gear 432. Furthermore, the other end of the first housing 450 is hinged to the second housing 460.

The bag according to the present embodiment includes the first housing 450 and the second housing 460, which are hinged to each other, and the first rotation gear 431 and the second rotation gear 432 follow the movement direction of the foldable section, so that the convenience of a user can be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed are:

1. A bag having a handle unit with improved precision of an extendable length, the bag comprising:
a body; and
a handle unit mounted on one side of the body such that a user carries the body,
wherein the handle unit comprises:
a housing coupled with one side of the body and having an installation space therein;
a foldable section arranged in the installation space and having a configuration in which a plurality of links cross each other such that the plurality of links are extended and contracted in folded or unfolded states;
a lock gear section that fixes an extendable length of the foldable section and is coupled to an upper end of the foldable section to reduce tolerance occurring when the foldable section is extended and contracted; and
a lock gear adjustment section that adjusts driving of the lock gear section such that the foldable section is extended and contracted according to manipulation of a user.

2. The bag of claim 1, wherein the lock gear section comprises:
a first rotation gear that rotates in a clockwise direction or a counter clockwise direction when the foldable section is extended and contracted;
a second rotation gear arranged adjacent to the first rotation gear and rotating in a direction opposite to a rotation direction of the first rotation gear when the foldable section is extended and contracted; and
a lock gear interposed between the first rotation gear and the second rotation gear to control rotation of the first rotation gear in such a way to be engaged with or separated from the first rotation gear according to adjustment of the lock gear adjustment section.

3. The bag of claim 2, wherein the first rotation gear is formed in the inner peripheral surface thereof with a plurality of lock gear grooves,
wherein the lock gear comprises:
a gear body; and
a plurality of first teeth formed along a peripheral surface of the gear body to be engaged with the lock gear grooves.

4. The bag of claim 3, wherein the first rotation gear is formed with at least one first protrusion insertion groove, and the bag further includes an adjustment member which is inserted into the first protrusion insertion groove according to the adjustment of the lock gear adjustment section to separate the first teeth from the lock gear grooves.

5. The bag of claim 4, wherein the second rotation gear is formed with at least one second protrusion insertion groove, and the lock gear further includes at least one second insertion protrusion provided one side of the gear body adjacent to the second rotation gear and having a shape corresponding to the second protrusion insertion groove.

6. The bag of claim 5, wherein the lock gear adjustment section comprises:
a grasping part grasped by a user;
a pair of extension parts extending from both ends of the grasping part to the adjustment member; and
a pair of pressing parts provided between the extension parts and the adjustment member to press the adjustment member such that the lock gear is separated from the first rotation gear.

7. The bag of claim 6, wherein the adjustment member is provided at one side thereof with a first inclination surface having a tapered shape toward an inner side from a surface thereof, and the pressing part includes a pressing protrusion having a second inclination surface corresponding to the first inclination surface.

8. The bag of claim 2, further comprising:
a pressing plate provided adjacent to one side of the second rotation gear; and
an elastic member interposed between the housing and the pressing plate to elastically press the pressing plate.

9. The bag of claim 2, further comprising:
a centering section coupled with the first rotation gear and the second rotation gear to allow a rotational degree of the first rotation gear to coincide with a rotational degree of the second rotation gear.

10. The bag of claim 9, wherein the centering section comprises:
a centering gear having a plurality of second teeth;
a first rack gear provided at an upper end of the first rotation gear and having a plurality of third teeth engaged with the second teeth; and
a second rack gear provided at an upper end of the second rotation gear and having a plurality of fourth teeth engaged with the second teeth.

11. The bag of claim 1, further comprising:
a tolerance restriction section provided at a lower end of the housing and applying elastic force in a direction opposite to an extension direction of the foldable section to reduce tolerance occurring when the foldable section is extended.

12. The bag of claim 11, wherein the tolerance restriction section comprises:
a guide member coupled with a link pin passing through a center portion of a pair of links arranged at the lower end of the housing among the plurality of links and moving up and down along one side of the housing; and
a pair of elastic springs provided adjacent to an upper end of the guide member to apply elastic force downward when the guide member moves up.

13. The bag of claim 12, wherein the pair of elastic springs are symmetrical to each other about the guide member such that one end of each elastic spring is fixed to the housing and the other end of each elastic spring is adjacent to the upper end of the guide member.

14. The bag of claim 12, wherein the housing is formed at one side of the lower end thereof with a first guide slit, and the guide member moves up and down relative to the housing along the first guide slit.

15. The bag of claim 1, wherein the housing is formed at one side of an upper end thereof with a second guide slit, and a pair of links arranged at a lower end of the housing among the plurality of links are coupled with each other by a movable pin coupled to move up and down relative to the second guide slit such that the pair of links move up and down along the second guide slit.

16. The bag of claim 15, wherein the movable pin comprises:
a first expansion part;
a second expansion part spaced apart from the first expansion part by a predetermined interval;
a third expansion part spaced apart from the second expansion part by a predetermined interval and protruding outward from the housing;
a first small diameter part having a diameter smaller than a diameter of the first expansion part and a diameter of the second expansion part and connecting the first expansion part to the second expansion part; and
a second small diameter part having a diameter smaller than a diameter of the second expansion part and a diameter of the third expansion part and connecting the second expansion part to the third expansion part.

17. The bag of claim 1, wherein the foldable section comprises:
a first unit link provided at one end thereof with a coupling protrusion; and
a second unit link formed at one end thereof with a coupling hole into which the coupling protrusion is inserted and coupled with the first unit link.

18. The bag of claim 17, wherein the coupling protrusion has a length sufficient to protrude by passing through the coupling hole, and the foldable section further comprises:
a washer coupled with one end of the coupling protrusion;
a fixing pin inserted into a coupling groove formed in a center portion of the coupling protrusion and the coupling hole; and
a cover member provided to cover one end of the first unit link, one end of the second unit link, and the washer.

19. The bag of claim 1, wherein the foldable section comprises:
a first unit link formed at both ends thereof with a first coupling hole;
a second unit link having an upper end coupled to a lower end of the first unit link and formed at both ends thereof with a second coupling hole; and
a coupling pin extending by passing through the first coupling hole and the second coupling hole to pivotably couple the first unit link to the second unit link.

20. The bag of claim 19, wherein the coupling pin comprises:
a first protrusion protruding from one side of the first unit link;
a second protrusion spaced apart from the first protrusion by a predetermined interval to be arranged at a coupling point of the first unit link and the second unit link;
a third protrusion spaced apart from the second protrusion by a predetermined interval to protrude from one side of the second unit link;
a first connection part having a diameter smaller than a diameter of the first protrusion and a diameter of the second protrusion and connecting the first protrusion to the second protrusion; and
a second connection part having a diameter smaller than a diameter of the second protrusion and a diameter of the third protrusion and connecting the second protrusion to the third protrusion, and
wherein the foldable section comprises:
a first cover part coupled with the first connection part to cover one end of the first unit link; and
a second cover part coupled with the second connection part to cover one end of the second unit link.

21. The bag of claim 20, wherein the first cover part comprises:
a first rotation pin formed one side thereof with an opening and coupled with the first connection part; and
a first rotation member that receives the first rotation pin therein, and
the second cover part comprises:
a second rotation pin formed one side thereof with an opening and coupled with the second connection part; and
a second rotation member that receives the second rotation pin therein.

22. The bag of claim 1, wherein the lock gear section comprises:
a first rotation gear rotating in a clockwise direction or a counter clockwise direction when the foldable section is extended and contracted;
a second rotation gear arranged adjacent to the first rotation gear and rotating in a direction opposite to a rotation direction of the first rotation gear when the foldable section is extended and contracted; and
a lock gear interposed between the first rotation gear and the second rotation gear to control rotation of the first rotation gear,
wherein the lock gear adjustment section includes a push button provided adjacent to the first rotation gear to separate the lock gear from the first rotation gear according to manipulation of a user.

23. The bag of claim 22, wherein each of the first rotation gear and the second rotation gear comprises:
a rotation body;
a receiving part extending from one end of the rotation body and bent, and having a gear in a longitudinal direction thereof; and
a grip housing grasped by a user and formed therein with a receiving space for receiving the receiving part when the foldable section is extended and contracted.

24. The bag of claim 23, further comprising:
a centering gear provided in the grip housing and engaged with the gear to allow a rotational degree of the first rotation gear to coincide with a rotational degree of the second rotation gear.

25. The bag of claim 22, further comprising:
an elastic member interposed between the second rotation gear and the lock gear to elastically press the lock gear and made of an elastic material.

26. The bag of claim 22, further comprising:
a first housing having a first end hinged to one side of the first rotation gear; and
a second housing having a first end hinged to one side of the second rotation gear,
wherein a second end of the first housing is hinged to a second end of the second housing, the first end of the first housing facing the second end of the first housing, the first end of the second housing facing the second end of the second housing.
